(19) United States
(12) Patent Application Publication
(10) Pub. No.: US 2009/0016358 A1
(43) Pub. Date: Jan. 15, 2009

(54) METHOD FOR TRANSMITTING DATA IN VIRTUAL WAN AND SYSTEM THEREOF

(75) Inventor: Ming Tang Lee, Hsinchu (TW)

Correspondence Address: WPAT, PC;INTELLECTUAL PROPERTY ATTORNEYS, 2030 MAIN STREET, SUITE 1300, IRVINE, CA, 92614, US

(73) Assignee: NETKLASS TECHNOLOGY, INC., HSINCHU (TW)

(21) Appl. No.: 12/167,142

(22) Filed: Jul. 2, 2008

Related U.S. Application Data
(60) Provisional application No. 60/949,305, filed on Jul. 12, 2007.

(51) Int. Cl. H04L 12/56

(52) U.S. Cl. 370/395.53

(57) ABSTRACT

A system for transmitting data in a virtual WAN comprises a plurality of routers, and each router comprises at least one connection port, a network status receiver and a redirection-processing unit. The network status receiver is configured to obtain bandwidth utilization information of other routers through the connection port. The redirection-processing unit is configured to determine whether the router needs to conduct a redirection and to establish a feasible redirection path based on the bandwidth utilization information of other routers.

### BACKGROUND OF THE INVENTION

1. Field of the Invention

The present invention relates to a method and system for transmitting data in a virtual wide area network (WAN), and more particularly to a method and system for transmitting data in a virtual WAN by duly allocating bandwidth resource.

2. Description of the Related Art

Packets are basic elements in data transmission of a network, and usually a multitude of packets contend for limited bandwidth resources. If the network bandwidth is sufficient to serve packet flows, the packet transmission works normally. However, in case the network bandwidth is insufficient to support packet flows, an undesirable congestion occurs. The above situation is analogous to the roadway in the real world. A possible method to reduce the impact of congestion is to allocate suitable roadways for different vehicles. For example, while motorcycles and buses run on their respective roadways, even if an accident occurs on the roadway for motorcycles, the buses can still run smoothly on their roadway without any impact. The bandwidth management is similar to the idea above, especially addressing the necessary network bandwidth for some important application programs.

With the increasing popularity of the Internet, not only do large corporations require a large amount of network bandwidth on the Internet, but also many small office, home office (SOHO) enterprises are eager for large amounts of network bandwidth. However, network bandwidth is expensive and limited, and it is impossible to obtain unlimited expansion following the user's needs. To resolve the dilemma, using a bandwidth management technique to effectively allocate the limited bandwidth appears to be a feasible solution.

### SUMMARY OF THE INVENTION

The method for transmitting data in a virtual WAN in accordance with one embodiment of the present invention comprises the steps of: each router periodically receiving bandwidth utilization information of other routers; a requesting router selecting at least one other router in accordance with the bandwidth utilization information; and the requesting router redirecting packets through the selected router to the Internet.

The system for transmitting data in a virtual WAN in accordance with one embodiment of the present invention comprises a plurality of routers, and each router comprises at least one connection port, a network status receiver and a redirection-processing unit. The network status receiver is configured to obtain bandwidth utilization information of other routers through the connection port. The redirection-processing unit is configured to determine whether the router needs to conduct a redirection and to establish a feasible redirection path based on the bandwidth utilization information of other routers.

The system for transmitting data in a virtual WAN in accordance with one embodiment of the present invention comprises a plurality of routers, and each router receives bandwidth utilization information of other routers, performing a packet redirection in accordance with the information, wherein the total output bandwidth of the system is equal to the sum of the output bandwidth of each router in the system.

### BRIEF DESCRIPTION OF THE DRAWINGS

The invention will be described according to the appended drawings in which:

FIG. 1 shows a system for transmitting data in a virtual WAN in accordance with an embodiment of the present invention;

FIG. 2 shows a flow chart in accordance with one embodiment of the present invention;

FIG. 3 exemplifies a router;

FIG. 4 shows a method for transmitting network data in a virtual WAN in accordance with one embodiment of the present invention; and

FIG. 5 shows a method for transmitting network data in a virtual WAN in accordance with one embodiment of the present invention.

### PREFERRED EMBODIMENT OF THE PRESENT INVENTION

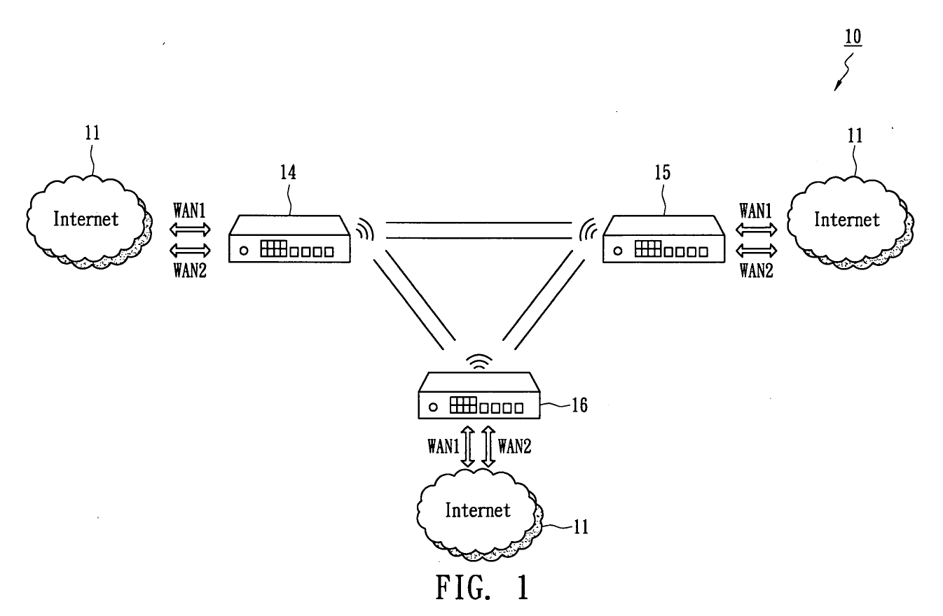

FIG. 1 shows a system for transmitting data in a virtual WAN in accordance with an embodiment of the present invention. A plurality of routers 14, 15 and 16 organize the system 10 by a manner of wireless backbone module, and each router uses two WAN connection ports WAN1, WAN2 to connect to the Internet 11. As a result, the total output bandwidth of the system 10 is the sum of the output bandwidth of each router in the system 10. In other words, a greater number of routers in the system 10 corresponds to greater available output bandwidth. The connection topology of the system 10 is not limited to any specified structure, and the mesh-shaped structure shown in FIG. 1 is merely an example. In addition, the present invention is characterized by its decentralized basis, and thus exhibits a highly reliable and cost-effective behavior. If a router 14 fails to connect to the Internet 11, e.g., due to malfunction in connection to the Internet or traffic congestion, the router 14 connects to the router 15 first through a wireless network and then connects to the Internet 11. Each router in the system 10 periodically obtains connection status and bandwidth utilization information of two connection ports of the host router and other routers. For example, through bandwidth utilization discover protocol (BUDP), each router in the system 10 is able to obtain the above information. In addition, the optimized link status routing protocol (OLSR) defined in the RFC 3626 standard specifies how to periodically collect data in a wireless mesh-based network and then calculates a best routing path. Furthermore, an ad hoc on-demand distance vector (AODV) protocol can quickly establish the path between the host and its intended destination. The system 10 is able to quickly respond and locate desirable paths upon changes in the network topology. One embodiment of the present invention is to use the BUDP, OLSR or AODV protocol to periodically obtain the status and bandwidth utilization information of connection ports of each device in the system 10. However, the above protocols are optional, and users can freely define their preferred routing paths.

The system 10 can further define upstream and downstream thresholds while the traffic of the network is congested. If the bandwidth utilization of connection ports of a router 14 is greater than the threshold, aside from via the router 14 itself, the other routers 15, 16 may be limited from connecting to the Internet 11 through those connection ports. Alternatively, if the bandwidth utilization of connection ports of a router 14 is greater than the threshold, the router 14 may be set to connect to the Internet 11 through connection ports of the routers 15, 16. By utilizing the advantages of the above BUDP, OLSR or AODV protocol or threshold setting, each device in the system 10 can obtain the bandwidth utilization of other devices. As a result, even if all WAN connection ports of the router 14 fail, the router 14 can still connect to the Internet through the router 15 or 16 whose connection ports have bandwidth utilization lower than the predetermined threshold. Even if one segment of the system 10 is congested, the present invention can redirect the path to other devices possessing available bandwidth, resolving the problem of traffic congestion by auto fail-over technique and ensuring connection stability.

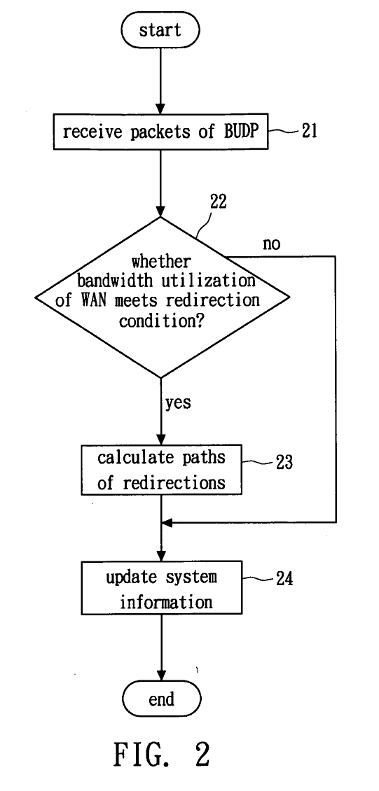

FIG. 2 shows a flow chart in accordance with one embodiment of the present invention. In step 21, each router in the system 10 periodically receives BUDP packets from other routers. In step 22, the router determines whether the bandwidth utilization of its two WAN connection ports is greater than a predetermined upper threshold or less than a lower threshold. If greater than an upper threshold, the virtual WAN function is actuated. If less than a lower threshold, then the virtual WAN function is suspended. To avoid intermittent switch-on and switch-off nearby the thresholds, the lower threshold is set a sufficient difference from the upper threshold. For example, the upper threshold is defined as 60%, and the lower threshold is defined as between 50% and 40%. In step 23, if the bandwidth utilization of the two connection ports exceeds the upper threshold, a redirection is conducted and a best or preferred path is estimated in accordance with a BUDP, OLSR or AODV protocol or user-defined routing path. In determining the best or preferred redirection path, the host router obtains bandwidth utilization of connection ports of other devices in the system 10 as well as hop count and wireless interface bit rate information so as to determine which remote router is best able to act as its redirect gateway. In step 24, the host updates information of each router in the system 10 in accordance with received BUDP packets. The information includes the Internet address (IP) of the local area network (LAN) coupled to the router, bandwidth utilization of WAN, host name, etc.

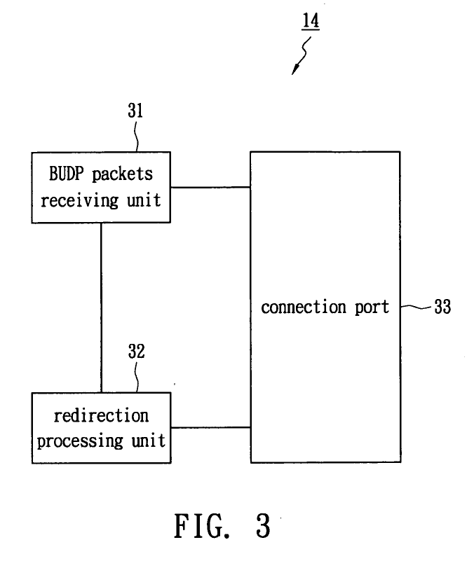

FIG. 3 exemplifies a router. The router 14 includes a network status (e.g., BUDP) receiver 31, a redirection-processing unit 32 and connection ports 33. The network status receiver 31 receives bandwidth utilization information of other routers through the connection ports, and communicates to the redirection-processing unit 32. The redirection-processing unit 32 stores the upper threshold and lower threshold directly or indirectly by a memory, and determines whether the bandwidth utilization of the connection ports 33 of this host router is over the upper threshold or under the lower threshold. If the bandwidth utilization of the two WAN connection ports exceeds the upper threshold, a best or preferred redirection path is calculated in accordance with information of other routers obtained from BUDP packets, e.g., bandwidth utilization, hop count and wireless interface transmission speed coupled to the host. The redirection-processing unit 32 further updates information of each router in the virtual WAN system, including the LAN address of the router, bandwidth utilization of WAN and host name, etc.

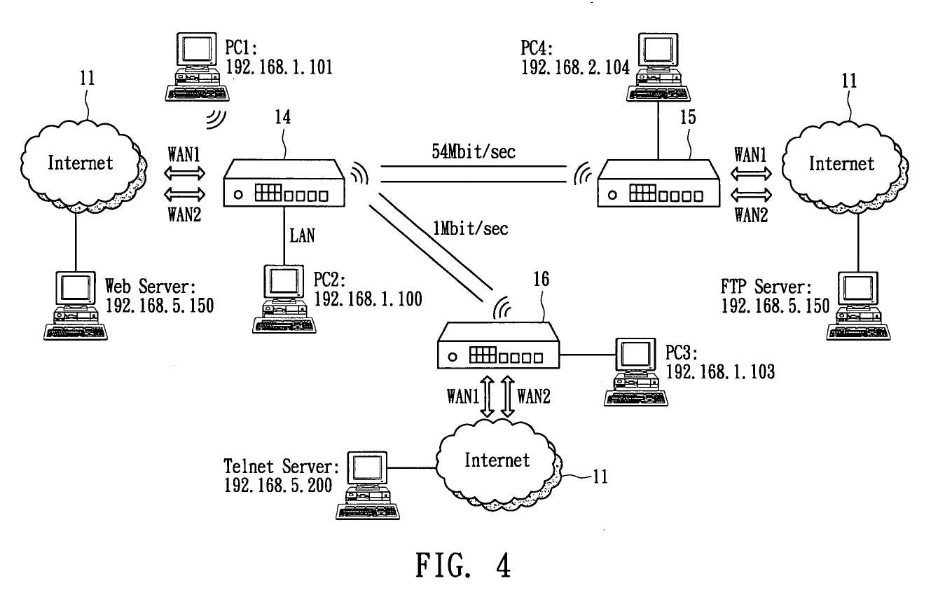

FIG. 4 shows a method for transmitting network data in a virtual WAN in accordance with one embodiment of the present invention. Assuming that the maximum bandwidth of two WAN connection ports of each router is 10M bits, and at a certain time the wireless transmission speed and remaining available bandwidth of two WAN connection ports of routers 14, 15, 16 are shown in the figure. Both of the routers 15, 16 connect to the router 14 through a wireless interface; therefore the hop count is one. Assuming that the virtual WAN function is actuated if the bandwidth utilization of WAN connection ports of the router 14 exceeds 60%, as set by an individual user, and the virtual WAN function is suspended if the bandwidth utilization of WAN connection ports of the router 14 is lower than 40%. Therefore if at a certain time the bandwidth utilization of the two WAN connection ports reaches 70%, the router 14 will actuate the virtual WAN function, and use hop count, wireless transmission speed and remaining bandwidth of WAN to separately calculate the scores that the router 14 uses to assess the ability of the routers 15, 16 to act as remote redirection gateways. For example, a user-defined routing path function F(X, Y, Z) is employed, where X represents hop count, and X>=1; Y represents wireless transmission speed, and 0<=Y<=54; Z represents remaining bandwidth of WAN, and Z>=0. Assuming that the score of the routing path through the router 15 is F(X, Y, Z)=1.2, and the score of the routing path through the router 16 is F(X, Y, Z)=1.0185, then the router 14 will choose the router 15 as a remote redirection gateway in accordance with the above scores. All packets of the computers in the LAN connected to the router 14 will be forwarded to the router 15 first, and then transmitted to the Internet 11 through the two WAN connection ports of the router 15. Meanwhile, if the bandwidth utilization of the connection ports of the router 14 slows down to 30%, then the router 14 will stop the virtual WAN function, and all packets of the computers in the LAN connected to the router 14 will be transmitted to the Internet 11 through the two WAN connection ports of the router 14.

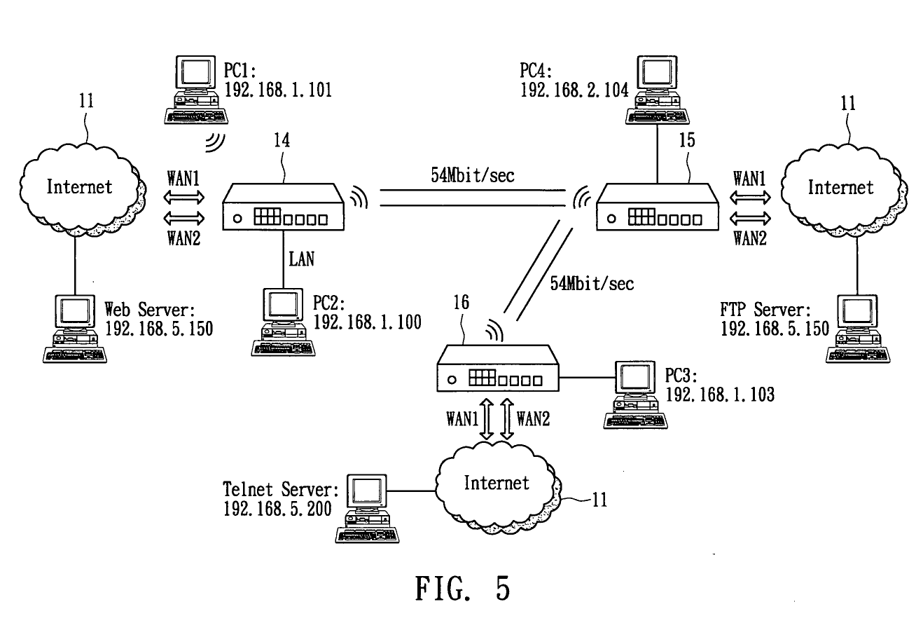

FIG. 5 shows a method for transmitting network data in a virtual WAN in accordance with one embodiment of the present invention. The router 15 is connected to the router 14 through a wireless interface, so the hop count is equal to one; the router 16 is indirectly connected to the router 14 through the router 15, so the hop count is equal to two. Assuming that at a certain time the bandwidth utilization of the two WAN connection ports of the router 14 reaches 70% (higher than the upper threshold 60%), the router 14 will actuate the virtual WAN function, and use the hop count, wireless transmission speed and remaining bandwidth of WAN to separately calculate the scores that the router 14 employs to assess the ability of the routers 15, 16 to function as a remote redirection gateway. Assuming that the score F(X, Y, Z) of the router 15 is 1.2, and the score F(X, Y, Z) of the router 16 is 1.5, then the router 14 will select the router 16 to act as its remote redirection gateway. All packets of the computers in the LAN connected to the router 14 will be forwarded to the router 16 first, and then transmitted to the Internet 11 through the two WAN connection ports of the router 16. Meanwhile, if the bandwidth utilization of the connection ports of he router 14 slows down to 30%, then the router 14 will stop the virtual WAN function, and all packets of the computers in the LAN connected to the router 14 will be transmitted to the Internet 11 through the two WAN connection ports of the router 14.

The present invention integrates the total output bandwidth of the system 10 to be the sum of the output bandwidth of each router in the system 10 through packet redirection between the routers. Consequently, the insufficient bandwidth of an individual router at a certain time is resolved and the total output bandwidth of the system is increased. The above-described embodiments of the present invention are intended to be illustrative only. Numerous alternative embodiments may be devised by persons skilled in the art without departing from the scope of the following claims.

What is claimed is:

1. A method for transmitting data in a virtual wide area network (WAN), comprising the steps of:
each router periodically receiving bandwidth utilization information of other routers;
a requesting router selecting at least one other router in accordance with the bandwidth utilization information; and
the requesting router redirecting packets through the selected router to the Internet.

2. The method of claim 1, further comprising the steps of:
setting an upper threshold and a lower threshold;
actuating a redirection if the bandwidth utilization of the requesting router is greater than the upper threshold; and
suspending the redirection if the bandwidth utilization of the requesting router is less than the lower threshold.

3. The method of claim 1, wherein a redirection is actuated if the requesting router fails.

4. The method of claim 2, wherein the upper threshold is greater than the lower threshold by at least 10%.

5. The method of claim 1, wherein each router receives bandwidth utilization information of other routers by a bandwidth utilization discover protocol.

6. The method of claim 1, wherein the requesting router uses an optimized link status routing protocol, ad hoc on-demand distance vector or user-defined routing path to locate the selected router.

7. The method of claim 1, further comprising a step of suspending packets of other routers from connecting to the Internet through the router whose bandwidth utilization is greater than a threshold.

8. The method of claim 6, wherein the user-defined routing path locates the selected router in accordance with bandwidth utilization, hop count and wireless interface transmission speed.

9. The method of claim 1, wherein the requesting router further updates the bandwidth utilization information of other routers upon establishment of the redirection.

10. The method of claim 9, wherein the information update includes the addresses of the routers in a local area network (LAN), the bandwidth utilization of the WAN and host names.

11. A system for transmitting data in a virtual WAN, comprising a plurality of routers, each router comprising:
at least one connection port;
a network status receiver configured to obtain bandwidth utilization information of other routers through the connection port; and
a redirection-processing unit configured to determine whether the router needs to conduct a redirection and to establish a feasible redirection path based on the bandwidth utilization information of other routers.

12. The system of claim 11, wherein the redirection-processing unit sets an upper threshold and a lower threshold, and if the bandwidth utilization of the requesting router is over the upper threshold, a redirection is actuated; if the bandwidth utilization of the requesting router is lower than the lower threshold, the redirection is suspended.

13. The system of claim 11, wherein the network status receiver uses a bandwidth utilization discover protocol to obtain the bandwidth utilization information of other routers.

14. The system of claim 11, wherein the redirection-processing unit uses an optimized link status routing protocol, ad hoc on-demand distance vector or user-defined routing path to locate the selected router.

15. The system of claim 14, wherein the user-defined routing path locates the selected router in accordance with the bandwidth utilization, hop count and wireless interface transmission speed.

16. The system of claim 11, wherein the redirection-processing unit further updates the bandwidth utilization information of other routers upon establishment of the redirection.

17. A system for transmitting data in a virtual WAN, comprising a plurality of routers, each router receiving bandwidth utilization information of other routers and performing a packet redirection in accordance with the information, wherein the total output bandwidth of the system is equal to the sum of the output bandwidth of each router in the system.

18. The system of claim 17, wherein each router sets an upper threshold and a lower threshold, and if the bandwidth utilization of the router is over the upper threshold, a redirection is actuated; if the bandwidth utilization of the router is lower than the lower threshold, the redirection is suspended.

19. The system of claim 17, wherein the router uses a bandwidth utilization discover protocol to obtain the bandwidth utilization information of other routers.

20. The system of claim 17, wherein the redirection locates at least one other router to redirect packets in accordance with the bandwidth utilization, hop count and wireless interface transmission speed.
